(19) United States
(12) Patent Application Publication
(10) Pub. No.: US 2022/0150294 A1
(43) Pub. Date: May 12, 2022

(54) SYSTEM FOR SOCIALLY SHARED AND OPPORTUNISTIC CONTENT CREATION

(71) Applicant: AT&T Intellectual Property I, L.P., Atlanta, GA (US)

(72) Inventors: Eric Zavesky, Austin, TX (US); David Crawford Gibbon, Lincroft, NJ (US); Jean-Francois Paiement, Sausalito, CA (US); Tan Xu, Bridgewater, NJ (US)

(73) Assignee: AT&T Intellectual Property I, L.P., Atlanta, GA (US)

(21) Appl. No.: 17/094,024

(22) Filed: Nov. 10, 2020

(51) Int. Cl. H04L 29/06

(52) U.S. Cl. CPC H04L 65/601

(57) ABSTRACT

Aspects of the subject disclosure may include, for example, socially shared and opportunistic content creation. A narrative may be partitioned in scenes, and rich descriptions are generated for each scene. Content contributors are selected to provide user generated content for each of the scenes, and the user generated content is scored and combined to create media content. Other embodiments are disclosed.

### FIELD OF THE DISCLOSURE

The subject disclosure relates to content creation.

### BACKGROUND

Classic content production methods are typically controlled by a few creative people and can be expensive. For example, a content creator may spend a significant amount of time generating storylines, developing characters, and producing the end product. Budgets required for new content production using classic methods continue to grow, while at the same time the demand for new content also continues to grow.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for socially shared and opportunistic content creation. Other embodiments are described in the subject disclosure.

One or more aspects of the subject disclosure include creating or receiving a narrative describing desired media content, and partitioning the narrative into a plurality of scenes. A description is generated for each of the plurality of scenes and one or more content contributors is selected to provide user generated content for each of the plurality of scenes. User generated content is received, evaluated, and combined to produce the desired media content. The desired media content may be presented to consumers that may be passive consumers of the content or active consumers in the content. Version history of the desired media content may be recorded.

One or more aspects of the subject disclosure include a processing system including a processor, a memory that stores executable instructions that, when executed by the processing system, facilitate performance of operations, the operations including creating or receiving a narrative describing desired media content, and partitioning the narrative into a plurality of scenes. The operations may further include generating a description for each of the plurality of scenes and selecting one or more content contributors to provide user generated content for each of the plurality of scenes. The operations may further include receiving, evaluating, and combining the user generated content to produce the desired media content. The desired media content may then be presented to consumers that may be passive consumers of the content or active consumers in the content. Version history of the desired media content may be recorded.

One or more aspects of the subject disclosure include a non-transitory machine-readable medium that includes executable instructions stored thereon that, when executed by a processing system including a processor, facilitate the performance of operations, the operations including creating or receiving a narrative describing desired media content, and partitioning the narrative into a plurality of scenes. The operations may further include generating a description for each of the plurality of scenes and selecting one or more content contributors to provide user generated content for each of the plurality of scenes. The operations may further include receiving, evaluating, and combining the user generated content to produce the desired media content. The desired media content may then be presented to consumers that may be passive consumers of the content or active consumers in the content. Version history of the desired media content may be recorded.

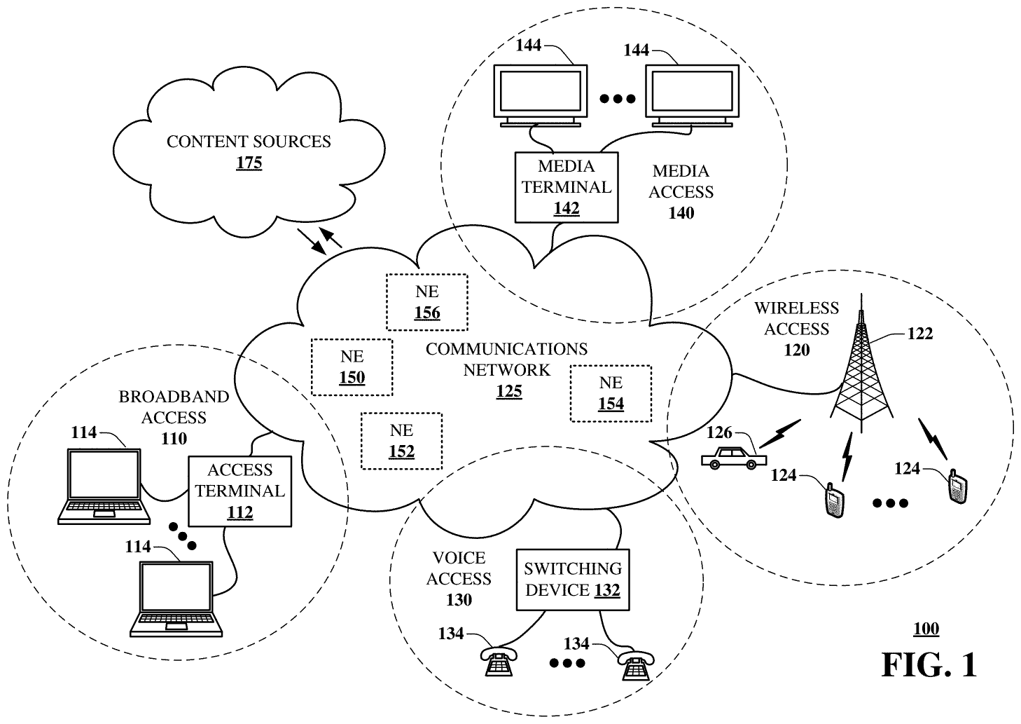

Referring now to FIG. 1, a block diagram is shown illustrating an example, non-limiting embodiment of a system 100 in accordance with various aspects described herein. For example, system 100 can facilitate in whole or in part socially shared and opportunistic content generation by creating or receiving a narrative describing desired media content, generating a description for each of the plurality of scenes, selecting one or more content contributors to provide user generated content for each of the plurality of scenes, and receiving, evaluating, and combining the user generated content to produce the desired media content.

Communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

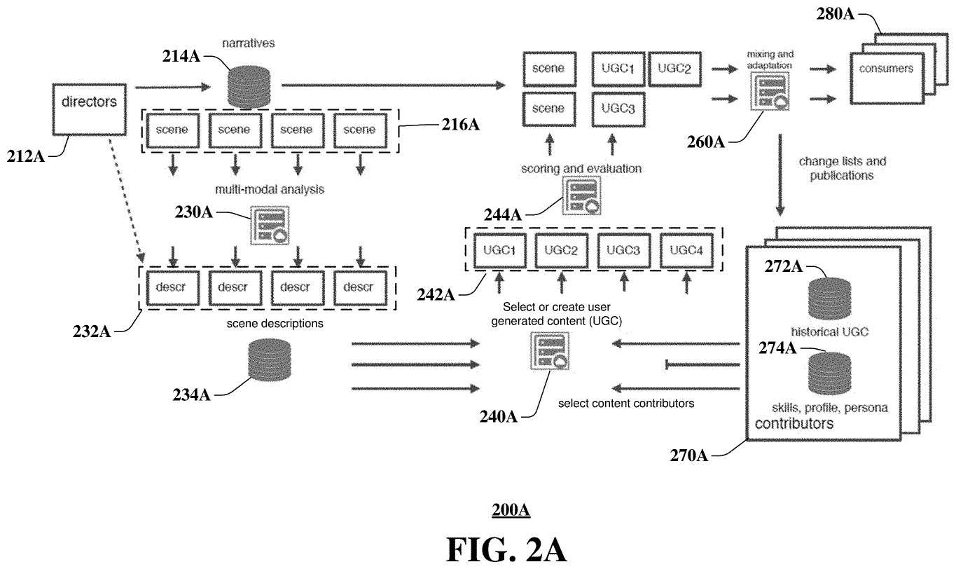

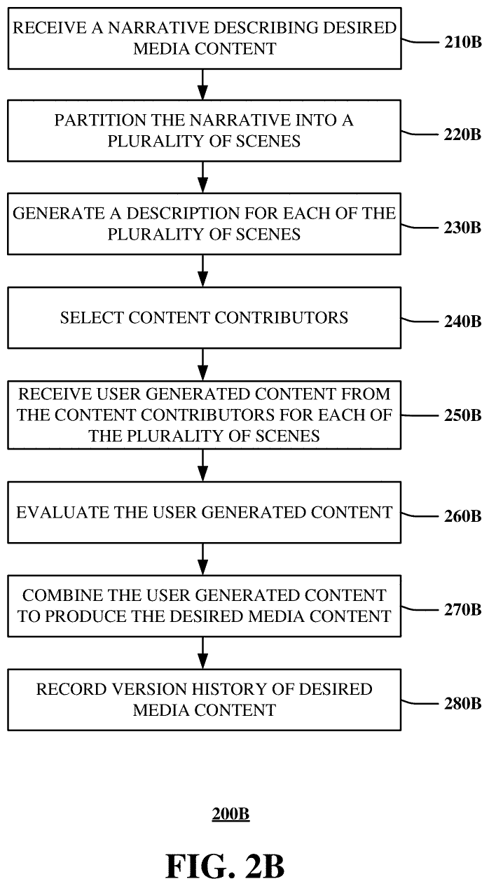

FIG. 2A is a block diagram illustrating an example, non-limiting embodiment of a system functioning within the communication network of FIG. 1 in accordance with various aspects described herein. Various embodiments described herein include intelligent selection of content contributors from their prior created content, interaction with the current production, and historical interactions; automated assessment to optimally combine different granularities of contributions from different contributors either in scale of content (a face, whole background, etc.) or skillset (familiarity with architecture, water, objects); and automated assessment of content fitness for presentation in a human-reviewed user experience (UX) or automatically using consistency (visual, audio, pose, mood, emotion) for composition in production.

Various embodiments described herein also include novel adaptation of contributed content using style transfer, stabilization, viewpoint modifications, etc. to stitch multiple contributions into a single production, which may also involve using detected features from contribution (person pose, visuals, objects) and projecting them onto a new production instead of direct usage; utilizing change-tracking (e.g., blockchain for public visibility) among content, where production changes may be version-controlled such that changes to an earlier contribution can be adapted and utilized in subsequent parts (e.g. a change to a character's shirt color in a video may be auto-propagated to all parts of the production's narrative).

As shown in FIG. 2A, one or more directors 212A may provide one or more narratives 214A that describe desired media content. As used herein, the term “directors” may refer to one or more persons, one or more computer processes, or any other source of information that can lead to a narrative of desired content. For example, a director may be a person with an idea for media content, such as a short video or a feature production, and that person may provide a narrative describing the desired media content. Also for example, a director may be a computer process that is directing media production. The provided narrative may include any information that is useful to describe desired media content. For example, a narrative may include a content storyboard, a script, or a set of visuals generated for a video project. In general, the director plays a role of an entity that has a concept for a narrative or a story that they want to describe. The director may play additional roles in the content creation as described below.

The scope of a particular narrative may be narrow or may be all encompassing. For example, a narrative may encompass a very specific idea intended to result in a short video clip or some other narrow produced content. Also for example, a narrative may be very wide in scope, such that it incorporates many scenes of a production that will ultimately result in content having multiple scenes cohesively tied together. In some embodiments, a narrative may be seeded by multiple ideas combined in a sequence. In some embodiments, a narrative may include audio clips, video clips, text, or any other content that may serve as an example of the desired content. For example, a particular spoken word may be included in the narrative, resulting in that spoken word being included in the generated content.

In some embodiments, the narrative is segmented into multiple scenes 216A. For example, in some environments, a narrative that includes a written script may be automatically partitioned to create multiple scenes. Also for example, the script may be manually marked up by a director and then manually partitioned to create multiple scenes from the marked-up script. Also for example, a video or a portion of a video may be automatically or manually partitioned to create multiple scenes. The scenes in these examples may include text, audio clips, video clips, still images, or any other information capable of specifying content.

In some embodiments, a single scene is generated. For example, the content production may be focused on producing a short video (e.g., a dancing costumed person). The narrative may include a short description of the desired person, the desired costume, the desired type of dance, whether it should be serious or humorous, and the like. In other embodiments, multiple scenes may be generated. For example, the content production may be focused on a short film or a feature production. In these examples, the number of scenes is potentially unlimited, and each scene may include information that describes the desired content to be produced for the scene.

The information that describes the desired content for each scene is referred to herein as a “seed,” and the combination of the scene and the seed is referred to herein as a “seeded scene.” Seeds may be information taken directly from a narrative, or may be inferred from the narrative, or related to the narrative in some other fashion. For example, a narrative may describe a science fiction bar that includes two aliens playing music, and two other characters bartering for services at a table. In some embodiments, two seeded scenes may be generated with a first scene having a seed of “two aliens playing music” and a second scene having a seed of “two characters bartering for services at a table.” In other embodiments, a first of two scenes may be seeded with “a hooded alien playing keyboards and a one-eyed alien playing a whimsical wind instrument,” and a second scene may be seeded with “a human and a non-human drinking frothy liquid and making large gestures.” The seeds may be automatically or manually generated from a narrative. For example, a computer process may perform the partitioning of the narrative into scenes and the seeding of the scenes, or a human director may perform the partitioning of the narrative into scenes and the seeding of the scenes. Also for example, in some embodiments, decisions for primary character, settings, etc., may be human contributed or suggested by an analysis of historical examples. In another embodiment, the narrative may take the form of an audio recording or of an alternate video representation. The video representation may be primitive or rudimentary such as a rapidly recorded mobile phone video that captures either the disclosure of the narrative (e.g., a talking head), or comprises a representation of the desired motion of the characters, perhaps in a simplified way which may include artifacts (bad lighting, jittery camera position, poorly executed acting or motion of the characters.)

The seeded scenes 216A are then analyzed by a multimodal analysis 230A to generate descriptions for the scenes at 232A. Any modality may be utilized for the analysis. For example, one modality may be text, imagery, video, or any other type of content. Further, other modalities include metadata such as creation date, contributor name, contextual information, or any other rating or description information.

As an example, the multimodal analysis 230A may determine that a particular type of picture should be included, or a picture of a particular item such as a statue or building should be included. Also for example, instead of having a specific narrative, there may be a joining of a single experience. An example of a single experience may be baking a cake, in which there are many ways to perform the experience such as different orders of incorporation of ingredients, where each results in the same outcome (e.g., a baked cake). In this example, the single experience does not focus on small details, but rather on the macro event.

The multimodal analysis results in rich descriptions 232A of the seeded scenes stored in storage device 234A. The descriptions 232A provide more specific descriptions of content to be included within the scenes and may be used to prompt for content. In some embodiments, the descriptions are more specific than the seeded scenes. For example, a seeded scene may specify a user going to a store, and the descriptions representing the scene may specify a person arriving in a vehicle, exiting the vehicle, walking past a soft drink machine, and entering a building through an automatic sliding glass door.

In some embodiments, the descriptions are targeted at user generated content creators. For example, a particular user may read a description and provide content that the user has previously generated. Also for example, a user may read a description and generate new content that satisfies the description. Also in some embodiments, the descriptions are targeted at automatic generators of content. For example, algorithms for automatic content generation may read the descriptions and generate content. Specifically, using technology like GANs (Generative Adversarial Networks), text passages, images, and audio fitting a description may be generated using a preexisting model (e.g. trained on other UGC content or specific to the scenes specified in 216A) and the variant descriptions 232A provided by the system. In still further embodiments, the descriptions are targeted at automatic collectors of content. For example, an automated process may read a description, and collect previously generated content from various repositories, including social media user accounts, websites, and the like.

At 240A, content contributors are selected from a group of potential contributors 270A. In some embodiments, potential contributors 270A have various attributes associated with them. For example, a potential contributor may have associated historical user generated content (UGC) 272A and skills, profile, and persona data 274A. Potential contributors may have any other attribute associated as well. For example, a potential contributor may have attributes that describe social media interactions such as groups to which the potential contributor belongs. Also for example, a potential contributor may have associated attributes that describe the contributor personally such as gender, race, income level, and the like.

In some embodiments, potential contributors are pooled into groups of contributors that have previously contributed specific types of content. In these embodiments, contributors may be selected from pools of potential contributors that have previously contributed to specific pools of previously generated content. For example, potential contributors belonging to a particular social media “channel” or interest group may be selected based on their subject matter interest and/or their contributions to these groups. As a specific example, a contributor to a bicycle enthusiast's group may be selected as a contributor for the current project when the rich description for a particular scene specifies subject matter related to bicycling. These contributors may be identified in any manner, including for example, by metadata tags, such as a user or video clip tagged with ‘bicycle’, or the subject of the content (a specific person, location, or activity) or the content itself (e.g., detecting a bicycle in a video clip).

In some embodiments, contributors are selected based on historical content creation as well as active contributions to the project. In addition, contributors may be selected based on a variety of other considerations, including for example, comparisons between potential contributions versus either the current content or the pool of contributors that are solicited. Examples include novelty, similarity, self-designated preferences, demographics, and the like. For example, contributor diversity may be achieved by biasing against having multiple contributors with similar attributes. As an example, if a majority of current contributors are identified as a first gender, future contributor selections may give priority to potential contributors that identify as other than the first gender. Although gender is provided as an example, the various embodiments are not limited in this respect. For example, any type of diversity may be enforced (e.g., race, social class, language preference, and the like).

In some embodiments, contributors may be selected based on rulesets (may be seeking only one contribution per user/area/demographic). Further, contributors may be selected based on potential alignment of behavior versus other users as roles (whether they are contributors, antagonists, builders, curators, creators, etc.). In addition, in some embodiments, other users may join as non-contributing audience members or commentators to give additional description of choices.

Selected contributors provide user generated content (UGC) 242. For example, in some embodiments, each selected contributor provides a segment of content for one scene. In other embodiments, selected contributors may provide user generated content segments for more than one scene. In some embodiments, selected contributors may generate new content to satisfy one or more descriptions 232A, and in other embodiments, selected contributors may provide previously generated content to satisfy one or more descriptions 232A.

In some embodiments, the user generated content is selected from historical content without contemporaneous involvement of the selected contributors. For example, content that satisfies a scene description may be identified and collected without active contributor involvement. Content may be identified based on any criteria, including text, imagery, or video within the media content, metadata associated with the content, or metadata associated with the contributor. In still further embodiments, a director may select content or approve the selection of content.

User generated content is scored and evaluated at 244A. Scoring and evaluation may be based on any criteria. For example, alignment of, or differences between, content segments may be measured using low-level feature cohesion between existing content; for example based on whether voices match, whether items are the same color, or whether there is good action coherence between scenes.

In some embodiments, scoring an evaluation of user generated content takes into account individual elements within the user generated content. For example, if more than one of the user generated content segments includes a middle aged person fulfilling a particular character role, and one other user generated content segment includes a teenager fulfilling that same character role, the content segment including the teenager may be scored lower so as to increase the likelihood that content with matching characters will be combined. Also for example, scoring and evaluation may take into account how well the user generated content satisfies the narratives and/or scene descriptions. For example, if the narrative or scene description specifies activities taking place at dusk, and a particular user generated content segment shows the sun high in the sky, that particular content segment may be scored lower than other content segments. In general, any criteria may be set for scoring and evaluation. The criteria may take into account the content itself, the contributor from which the content came, or any other criteria.

In some embodiments, each of the user generated content segments includes an indication corresponding to the scene description satisfied by the user generated content. In other embodiments, the scoring and evaluation determines the correlation between user generated content and the associated scene descriptions. For example, text, imagery, video, and the like included within a particular user generated content segment may be interpreted and then compared to the descriptions of the scenes, resulting in a pairing between the user generated content segments and the scene descriptions. In some embodiments, the pairing between user generated content segments and scene descriptions is performed automatically. In other embodiments, a user such as one of the directors may view the user generated content segments and manually provide the pairing.

Once user generated content is received, scored, evaluated, and paired with scene descriptions, the user generated content segments are mixed and combined at 260A. In some embodiments, user generated content segments are concatenated in scene order without additional processing to create the desired media content. In other embodiments, the user generated content segments are modified or adapted as they are combined. For example, in some embodiments, the user generated content may be modified at scene boundaries to smooth transitions between user generated content segments. Examples include, but are not limited to, combining or modifying attributes or target features of multiple content segments at scene boundaries (e.g., audio, pose, visual, etc.) adaptation, direct copy, etc. Alternatively, in some embodiments, a continuous mixing (or bias) is employed; or a user interface may allow one or more user generated content segments to be selected and “mixed” with a sliding scale.

In some embodiments, user generated content segments include 3D representations of scenes. During mixing and adaptation at 260A, the 3D representations may be rotated and/or translated, and a virtual camera may be placed anywhere in the 3D representation to create a 2D image or video of the 3D representation from any perspective.

In some embodiments, machine learning (ML) and/or artificial intelligence (AI) techniques may be used to stitch user generated content segments together. For example, in some embodiments, generative adversarial networks (GAN) may be used. In these embodiments, content within the scenes may be created or modified in a way that creates or modifies content to include in scenes and/or perform seamless transitions between the scenes. Examples include modifying human forms, including faces, postures, hair color, attire, skin color, and other features. Other examples include modifying environmental features, such as buildings, streets, cars, park benches, and any other content within the scenes.

In some embodiments, version history is kept to record versions of the created media content and/or the processes used to create the media content. For example, in some embodiments, a blockchain is maintained to record incremental changes to the created media content in a verifiable and public record. Version history enables source-control like branching and lineage to quickly cut, move, or reapply any historical changes. Versions may represent steps in a timeline, specific contributions, specific changes to contributions, GAN results, stitching results, etc.

In some embodiments, mixed and adapted user generated content may be used to update profiles of potential contributors. For example, historical user generated content 272A of a particular contributor may be updated with content that has been adapted at 260A. As a specific example, a user generated content segment at 242A may be modified using a GAN to change a character's appearance, and the resulting content segment may be used to update the historical user generated content associated with that user. That historical user generated content may then be used for future media content creation.

Mixed and adapted user generated content segments are combined and provided to consumers 280A as created media content that represents the desired media content described by narrative 214A. The created media content consumption and delivery may include traditional and interactive forms. For example, created media content may be delivered for passive consumption (no interaction, take the consensus version) or interactive consumption (allow end users to further tweak the content). In some embodiments, consumers may revise the created media content and additional versions may be published back to system for future consumption by others or for automated derivatives (e.g., the system may mix combinations of consumer versions) or piece-wise inclusion in later created media content (e.g., scene replacement in future content). In some embodiments, consumers that contribute to the version history may be used as indices into content (show me all scenes where user X contributed to action) to support later user cohort collection.

As an example of consumer interaction with content, a parent may disapprove of a scene in which a particular character is smoking. The parent, as a consumer of the media content, may make a change to remove characters that are smoking. In some embodiments, the change being made might be for the sole consumption of the consumer making the change, and in other embodiments, the change being made might be published back to the system to create a new version which is viewable by other consumers as well. In some embodiments, the new version is documented using the blockchain, so that a publicly viewable and publicly verifiable version history exists.

As another example of consumer interaction with content, a consumer may modify a style of the entire content or may modify a particular scene or may modify a particular segment of user generated content. For example, a particular user generated content segment may include an economy car, and a consumer may replace the economy car with a sports car and publish that back to the system as a new version. In general, a consumer may make any change to the media content based on any criteria in accordance with the various aspects described herein.

In some embodiments, the various actions described with reference to FIG. 2A may be performed on a computer that is local to a user such as a director, and in other embodiments, the various actions described herein may be performed in a distributed computing environment. For example, in some embodiments, the generation of narratives may be performed by a user on a local computer, any scoring, evaluation, mixing, and adapting may be performed in the cloud. Also for example, storage of user generated content, created content, version history, and the like may be performed in the cloud.

FIG. 2B depicts an illustrative embodiment of a method 200B in accordance with various aspects described herein. At 210B, a narrative describing desired media content is received. In some embodiments, the narrative is received from a director, which may be a person, a computer process, or any other entity capable of specifying a narrative for desired media content. Further, in some embodiments, the narrative is received by a processor in a distributed computing environment, such as a virtual server in the cloud. In other embodiments, the narrative is received at a local computer such as a desktop computer operated by a director.

The narrative may include any descriptive material capable of specifying desired media content. For example, a narrative may include text, imagery, videos, or the like. Also for example, the narrative may include a storyboard, a script, or examples of content that may be expanded upon to create the desired media content.

At 220B, the narrative is partitioned into a plurality of scenes. In some embodiments, this is performed automatically by a computer process. For example, a computer may parse the narrative into a plurality of scenes and then seed each scene with information either directly from the narrative or inferred from the narrative. Seeded scenes may include any amount of information. For example, a seeded scene may include only information that was part of the narrative. Also for example, a seeded scene may include additional information, such as character development information, background scene information, action sequences, desired interaction between characters, and/or any other information relevant to a scene.

At 230B, a description for each of the plurality of scenes is generated. In some embodiments, this is performed by a multimodal analysis that analyzes one or more modes of information within the seeded scenes. For example, a multimodal analysis may analyze text, imagery, video clips, or any other information in a seeded scene to generate rich descriptions of the seeded scenes. In some embodiments, the scene descriptions are modified by a director. For example, a director may verify that scene descriptions satisfy the narrative produced and received at 210B.

At 240B, content contributors are selected. In some embodiments, content contributors are selected from pools of content contributors based on one or more attributes. For example, a content contributor may be selected based on historical user generated content, or may be selected based on the contributor's alignment with, or membership in, a particular social media group. Examples include social media groups having an interest emphasis in particular topics that align with the scene description material. Content contributors may also be selected based on attributes of the potential contributors themselves. For example, potential contributors may be selected based on diversity requirements, location requirements, or any other attributes associated with the contributors.

At 250B, user generated content is received from the content contributors for each of the plurality of scenes. In some embodiments, the user generated content received from the content contributors is received in segments, where each segment corresponds to a portion of a scene description, a complete scene description, or a plurality of scene descriptions. In some embodiments, the user generated content is generated by a content contributor in response to being selected. In other embodiments, user generated content is selected from previously generated user generated content. And in still further embodiments, user generated content may be automatically generated based on historical user generated content and scene descriptions.

At 260B, the user generated content is scored an evaluated. In some embodiments, the user generated content is scored based on how well the user generated content segments align with scene descriptions. In other embodiments, user generated content segments are scored and evaluated based on how well they align with other user generated content segments received at 250B. In general, user generated content segments may be scored and evaluated based on any criteria.

At 270B, the user generated content is combined to produce the desired media content. In some embodiments, combining the user generated content includes concatenating user generated content segments for each scene, thereby producing the desired media content directly from the user generated content segments. In other embodiments, combining the user generated content includes mixing and adapting user generated content segments to produce the desired media content. For example, in some embodiments, user generated content segments may be modified at segment boundaries or scene boundaries. In these examples, machine learning and artificial intelligence processes may be performed to project content from a first user generated content segment to another user generated content segment to make transitions between content segments more seamless. For example, a particular character trait from a particular character in a first user generated content segment may be transferred to or superimposed on a character in a second user generated content segment to produce a character that is common to both user generated content segments. Also for example, a background scene in a first user generated content segment may be modified to match the background in a second user generated content segment.

In some embodiments, user generated content segments include 3D models of an environment, and combining the user generated content segments includes rotating and or transforming the 3D modeled environment and extracting a 2 dimensional scene having a particular viewpoint from each user generated content segment. In some embodiments, individual elements from 3D models are drawn from different user generated content segments and placed in the created media content.

At 280B, a version history of desired media content is recorded. In some embodiments, the version history is recorded using a blockchain. In other embodiments, the version history is recorded using a source code repository system or other system capable of tracking version history.

In some embodiments, modified user generated content is used to update historical user generated content for one or more content contributors. For example, content generated by a particular content contributor may be modified during the combining of the user generated content to produce the desired media content, and the modified user generated content may be published back to the content contributor for use at a later time.

The newly created content may be published to one or more consumers. The consumers of the content may consume the content in a classic fashion without any interaction. For example, a video created using processes described herein may be viewed on a television without any interaction by a consumer. In some embodiments, consumers may interact with the media content, producing new versions of the content that may be viewable solely by the consumer or may be published for viewing by other consumers. For example, a consumer may make a modification to the created content and that modification may be recorded as a version which may then be available for viewing or interacting by other consumers.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

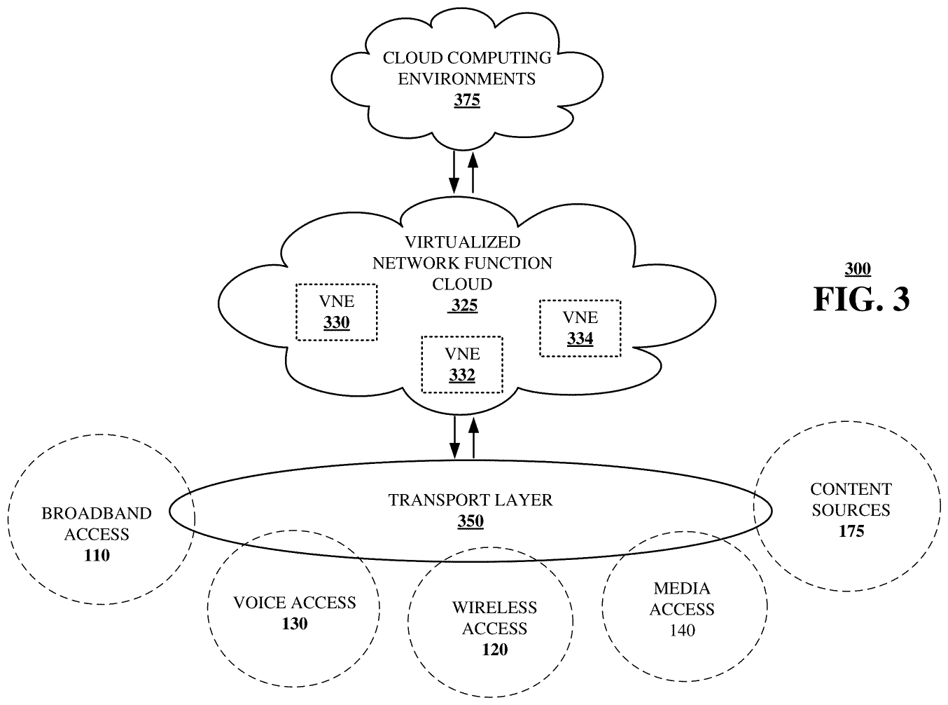

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C, and 3. For example, virtualized communication network 300 can facilitate in whole or in part the socially shared and opportunistic content creation as described herein.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

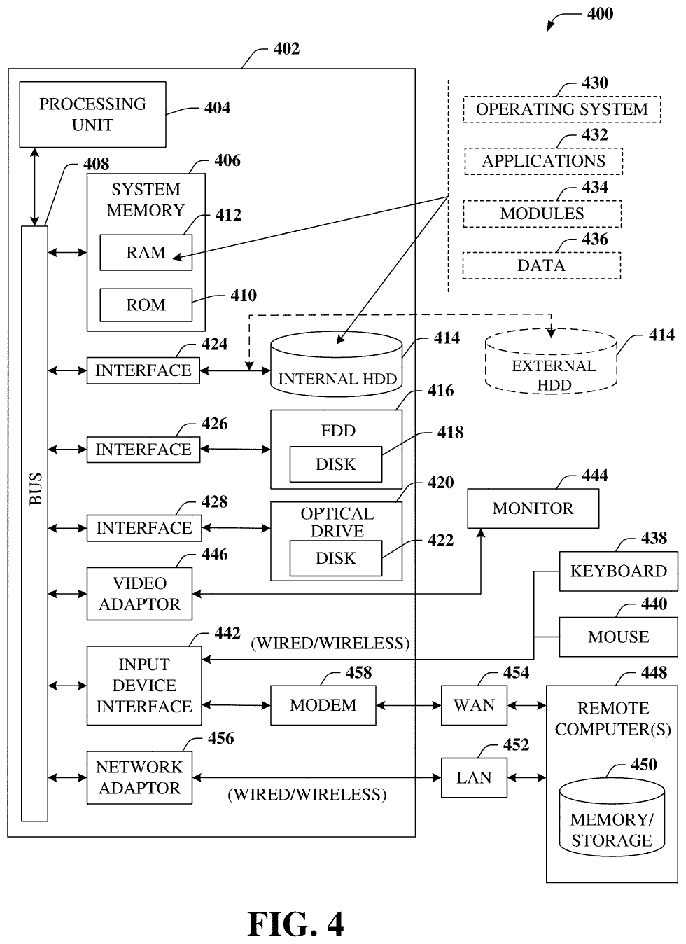

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part the socially shared and opportunistic content creation as described herein.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

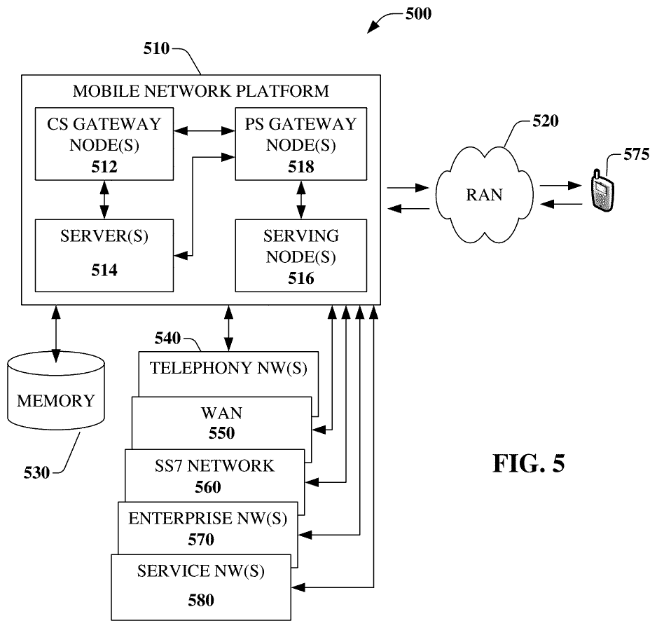

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part socially shared and opportunistic content creation as described herein. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

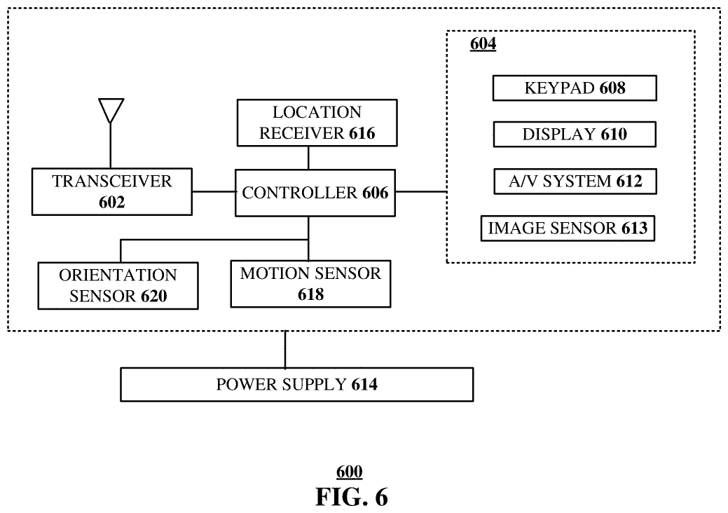

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part socially shared and opportunistic content creation as described herein.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” “subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” “data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving a narrative describing desired media content;
partitioning the narrative into a plurality of scenes;
generating a description for each of the plurality of scenes;
selecting content contributors;
receiving user generated content from the content contributors in response to the description for each of the plurality of scenes;
evaluating the user generated content; and
combining the user generated content for each of the plurality of scenes to produce the desired media content.

2. The device of claim 1, wherein the combining the user generated content for each of the plurality of scenes comprises modifying the user generated content at scene boundaries.

3. The device of claim 2, wherein the modifying the user generated content at scene boundaries comprises modifying the user generated content using a generative adversarial network (GAN).

4. The device of claim 1, wherein the receiving user generated content comprises receiving three dimensional (3D) content.

5. The device of claim 4, wherein the combining the user generated content for each of the plurality of scenes comprises performing modifying the user generated content at scene boundaries.

6. The device of claim 5, wherein the modifying the user generated content at scene boundaries comprises performing 3D transformations on the user generated content.

7. A non-transitory machine-readable medium, comprising executable instructions that, when executed by a processing system including a processor, facilitate performance of operations, the operations comprising:
receiving a narrative describing desired media content, the narrative including a storyline for a plurality of scenes;
partitioning the narrative into the plurality of scenes;
generating a description for each of the plurality of scenes;
selecting content contributors;
receiving user generated content from the content contributors in response to the description for each of the plurality of scenes;
evaluating the user generated content; and
combining the user generated content for each of the plurality of scenes to produce the desired media content.

8. The non-transitory machine-readable medium of claim 7, wherein the partitioning the narrative into the plurality of scenes comprises seeding each of the plurality of scenes with information related to desired scene content to create seeded scenes.

9. The non-transitory machine-readable medium of claim 8, wherein the generating the description for each of the plurality of scenes comprises a multimodal analysis that analyzes multiple modes of the seeded scenes.

10. The non-transitory machine-readable medium of claim 9, wherein the multiple modes comprise text, images, video, or a combination thereof.

11. The non-transitory machine-readable medium of claim 7, wherein the selecting content contributors comprises selecting content contributors based on previous contributions.

12. The non-transitory machine-readable medium of claim 7, wherein the selecting content contributors comprises selecting content contributors based on diversity of potential contributors.

13. The non-transitory machine-readable medium of claim 7, wherein the evaluating the user generating content comprises evaluating the user generated content based on diversity of the content contributors.

14. The non-transitory machine-readable medium of claim 7, wherein the combining the user generated content for each of the plurality of scenes comprises modifying the user generated content at scene boundaries.

15. The non-transitory machine-readable medium of claim 14, wherein the modifying the user generated content at scene boundaries comprises modifying the user generated content using a generative adversarial network (GAN).

16. The non-transitory machine-readable medium of claim 7, wherein the operations further comprise recording versions of the desired media content using a blockchain.

17. A method, comprising:
receiving, by a processing system including a processor, a narrative describing desired media content;
partitioning, by the processing system, the narrative into a plurality of scenes;
generating, by the processing system, a description for each of the plurality of scenes;
selecting, by the processing system, content contributors;
receiving, by the processing system, user generated content from the content contributors in response to the description for each of the plurality of scenes;
evaluating, by the processing system, the user generated content, wherein the evaluating comprises scoring user generated content segments based on how well a first description of one of the plurality of scenes is satisfied; and
combining, by the processing system, the user generated content for each of the plurality of scenes to produce the desired media content.

18. The method of claim 17, wherein the selecting content contributors comprises selecting content contributors based on associations with online groups.

19. The method of claim 17, wherein the combining the user generated content comprises combining audio received from a first content contributor with video from a second content contributor.

20. The method of claim 17, further comprising:
receiving a modification to the media content from a consumer of the media content; and
recording the modification using a blockchain.
